(19) United States
(12) Patent Application Publication
(10) Pub. No.: US 2026/0011862 A1
(43) Pub. Date: Jan. 8, 2026

(54) BATTERY ASSEMBLY

(71) Applicant: PLASTIC OMNIUM CLEAN ENERGY SYSTEMS RESEARCH, Lyon (FR)

(72) Inventors: Nicolas DERANGERE, Bruxelles (BE); Pierre OSZWALD, Bruxelles (BE); Philippe GEORIS, Bruxelles (BE); Antoine GEOFFROY, Bruxelles (BE)

(73) Assignee: PLASTIC OMNIUM CLEAN ENERGY SYSTEMS RESEARCH, Lyon (FR)

(21) Appl. No.: 19/123,628

(22) PCT Filed: Nov. 8, 2023
(86) PCT No.: PCT/EP2023/081141

§ 371 Date: Apr. 23, 2025

(30) Foreign Application Priority Data
Nov. 8, 2022 (FR) FR2211638

(51) Int. Cl. H01M 50/358; B60L 50/64; H01M 50/209; H01M 50/249; H01M 50/289; H01M 50/325; H01M 50/367

(52) U.S. Cl. CPC H01M 50/358; H01M 50/209; H01M 50/249; H01M 50/289; H01M 50/325; H01M 50/367; B60L 50/64; H01M 2200/20; H01M 2220/20

(57) ABSTRACT

A battery assembly includes a battery module having an alignment of a plurality of battery cells. Each battery cell is placed in an individual battery cell chamber and separated from each other by a separation plate. Each individual battery cell chamber includes a vent communicating with a discharge channel for discharging the gases generated by thermal runaway arranged in an upper portion of the battery module. The discharge channel is common for the plurality of battery cells and includes a lower wall made up of a plate configured to form a thermal shield, an upper wall made up of a plate configured to form a thermal shield and two side edges including a polymer-based material. The battery module includes a compression system provided with a gas outlet in fluid connection with the gas discharge channel.

The invention relates to a battery assembly configured to manage the escape of gases generated by thermal runaway within a battery cell of the battery assembly. More particularly, the invention relates to a battery assembly comprising at least one battery module, said battery module comprising an array of a plurality of battery cells and being provided with a channel for discharging gases generated by thermal runaway within a battery cell of the battery assembly.

A thermal runaway in a battery assembly occurs when the temperature of one or more battery cells rises to such an extent that it initiates chain reactions that accelerate chemical reactions within the battery cell or cells, contributing to the rapid release of thermal energy. Thermal runaway can be triggered by insufficient cooling of the battery cell(s) during the operation of the battery assembly. Thermal runaway can also be triggered by other events, such as a short-circuit, mechanical shock, exposure to extreme temperature, or manufacturing defect. During thermal runaway, hot gases and other flammable materials can escape from the battery cell or cells. If not properly managed, the gases generated can lead to fire or explosion. Therefore, thermal runaway on one or more high-capacity battery cells, particularly with NMC (Nickel, Manganese, Cobalt) technology, can lead to the release of gases whose temperature exceeds 900° C. within the battery assembly.

Already known in the prior art, in particular from US 2019/0173068 A1, but also from EP 2 637 235 A1, US 2015/214525 A1 and EP 2 538 470 A1, is a battery assembly comprising a battery module comprising an alignment of a plurality of battery cells, said battery module being provided with a gas discharge channel. In the disclosed module, the discharge channel is in fluid connection with the plurality of battery cells by means of a slot extending along the discharge channel, this slot being common to the plurality of battery cells. This arrangement ensures that the gases generated by thermal runaway within a battery cell are discharged. However, such a device for discharging the gases generated by thermal runaway within a battery cell does not greatly reduce the risk of thermal runaway in other battery cells.

One aim of the invention is to provide a battery assembly that minimizes the propagation of thermal runaway from one battery cell to other battery cells.

The object of the invention is a battery assembly comprising at least one battery module. According to the invention, the battery module comprises an alignment of a plurality of battery cells, each battery cell is placed in an individual battery cell chamber and separated from each other by a separation plate, each individual battery cell chamber comprises a vent communicating with a discharge channel for discharging the gases generated by thermal runaway arranged in an upper portion of the battery module, said discharge channel is common for the plurality of battery cells and comprises a lower wall made up of a plate configured to form a thermal shield, an upper wall made up of a plate configured to form a thermal shield and two side edges comprising a polymer-based material, and the battery module comprises a compression system provided with at least one gas outlet in fluid connection with the gas discharge channel.

Thus, a battery module wherein each battery cell is located in an individual battery cell chamber comprising a vent communicating with a channel for discharging gases generated by thermal runaway arranged in the upper part of the battery module reduces the risk that the thermal runaway will spread from one battery cell of the plurality of battery cells to the other battery cells. The presence of one vent per battery cell chamber reduces the risk of contact between gases generated by thermal runaway in one battery cell and other battery cells. Furthermore, the battery module is provided with a gas discharge channel arranged in its upper part, said discharge channel being common for the plurality of battery cells and comprising a lower wall consisting of a plate configured to form a thermal shield, an upper wall consisting of a plate configured to form a thermal shield and two side edges comprising a polymer-based material. Thus, a discharge channel with such a structure provides a discharge channel configured to reduce the propagation of heat generated within the battery assembly, while at the same time ensuring the flexibility of said channel to withstand significant temperature and pressure stresses associated with the discharging of gases generated by thermal runaway. Preferentially, the upper wall consisting of a plate configured to form a thermal shield is a stainless steel or ceramic plate. The presence of a compression system with at least one gas outlet in fluid connection with the gas discharge channel improves the durability and safety of the battery assembly, due to possible swelling of the battery cells during their lifespan. The compression applied to the battery cells by the compression system is linked to the battery cell technology but also to the format of the battery cells. Preferentially, the lower wall of the discharge channel consists of a metal or ceramic plate, preferentially a metal plate covered by a ceramic coating on its part exposed to the gases generated by thermal runaway. Preferentially, the upper wall of the gas discharge channel consists of a metal plate covered by a ceramic coating on its part exposed to the gases generated by thermal runaway. The notions of “upper” and “lower” relative to the gas discharge channel are taken with the ground as a reference for a battery assembly in operating position. The expression “a polymer-based material” means that the material comprises at least 50% by weight of said polymer.

According to a preferred embodiment, the battery assembly according to the invention is such that the polymer-based material comprises a polymeric foam.

Thus, the presence of a polymeric foam makes it possible, thanks to the height tolerance of the cells that make up the foam, to create a given sealing level and limit the volume of gas that could escape from the gas discharge channel located in the upper part of the battery module. The notion of “upper” relative to the battery module is taken with the ground as a reference for a battery assembly in operating position.

According to a preferred embodiment, the battery assembly according to the invention is such that the polymer-based material constituting the two side edges is covered with a metal film or a ceramic film, on at least its portions exposed to the gases generated by thermal runaway.

The presence of a metal or ceramic film on at least those parts of the side edges exposed to the gases generated by a thermal runaway prevents the polymer-based material from degrading through heat dissipation or thermal shielding.

According to a preferred embodiment, the battery assembly according to the invention is such that at least one of the two side edges of the channel for discharging gases generated by thermal runaway is constituted in part by a fold of the upper wall constituted by the plate configured to form a thermal shield. Preferentially, the two side edges of the channel for discharging the gases generated by thermal runaway are formed in part by a fold in the upper wall formed by the plate configured to form a thermal shield. More preferentially, the side edge(s) of polymer-based material are inserted into a groove or angle in the top wall formed by the plate configured to form a thermal shield.

In this way, the risk of degradation of the polymer-based material is reduced by folding back the upper wall formed by the plate configured to form a thermal shield constituting at least one of the two side edges of the channel for discharging the gases generated by thermal runaway, preferentially both side edges of the channel for discharging the gases generated by thermal runaway. Advantageously, the plate configured to form a thermal shield also incorporates a specific shape that makes it possible to protect the polymer-based material, this specific shape is constituted by a fold of the upper wall constituted by the plate configured to form a thermal shield, preferably said fold is in the form of a groove or an angle.

According to a preferred embodiment, the battery assembly according to the invention is such that the gas discharge channel is located in the center of the upper part of the battery module.

Thus, a discharge channel located in the center of the upper part of the battery module optimizes the discharging of gases generated by thermal runaway in the battery module. The expression “in the center of the upper part of the battery module” means that the gas discharge channel is located on a straight line cutting the upper part of the battery module into two approximately equal parts along the direction of alignment of the plurality of battery cells.

According to a preferred embodiment, the battery assembly according to the invention is such that the compression system provided with at least one gas outlet in fluid connection with the gas discharge channel comprises at least two compression plates located on either side of the battery module in the direction of alignment of the plurality of battery cells, at least one of the two plates, preferentially both plates, comprising a gas outlet in the form of a duct perpendicular to the direction of alignment of the plurality of battery cells, said duct being directed towards the bottom of the battery module.

Thus, a compression system comprising a gas outlet in the form of a duct perpendicular to the direction of alignment of the plurality of battery cells enables control of the outlet of gases generated by thermal runaway from the bottom of the battery module.

According to a preferred embodiment of the preceding embodiment, the battery assembly is such that said at least one of the two compression plates comprises a compression panel and a thermal protection panel comprising the gas outlet in the form of a duct perpendicular to the direction of alignment of the plurality of battery cells, said thermal protection panel being based on a material selected from a ceramic material and a metallic material, preferentially the thermal panel is made of steel. Preferentially, the compression board is based on Polyphtalamide (PPA).

Thus, the use of a thermal protection panel based on a material selected from a ceramic material and a metallic material minimizes propagation of the thermal energy of gases generated by a thermal runaway within the battery assembly. By the expression “a thermal protection panel being based on a material”, we mean that the thermal protection panel consists of at least 50% by weight of the said material.

According to a preferred embodiment, the battery assembly is such that it comprises a support frame for at least one battery module, said support frame comprising a central gas exhaust line and a gas exhaust area on the outer edges of the support frame, the gas exhaust line in the central part and the gas exhaust area on the outer edges of the support frame being in fluid connection with the gas outlet of the compression system, preferentially the gas outlet of the compression system is in the form of a duct within a compression plate of the battery module, said duct being perpendicular to the direction of alignment of the plurality of battery cells.

Thus, a battery assembly comprising a support frame for at least one battery module, said support frame comprising a gas exhaust line in its central part and a gas exhaust area on its outer edges, ensures optimum discharging of the gases generated by thermal runaway while optimizing their cooling when said support frame is close to a cooling plate.

According to a preferred embodiment, the battery assembly according to the invention is such that the gas exhaust line in the central part and the gas exhaust area on the outer edges of the support frame are provided with an outlet comprising a safety valve. Preferentially, the safety valve is a diaphragm valve, preferentially a Polytetrafluoroethylene (PTFE)-based diaphragm.

In this way, the presence of a safety valve enables a controlled release of the gases generated by thermal runaway.

According to a preferred embodiment, the discharge channel arranged in the upper part of the battery module has a number of baffles configured to guide gases generated by thermal runaway.

In this way, the gases generated by thermal runaway are more effectively discharged. In addition, the baffles help protect the vents by preventing the gases generated by thermal runaway that move through the exhaust channel from approaching them.

According to a preferred embodiment, the battery assembly comprises a cooling plate common to the entire battery module, or even common to all the battery modules. Said cooling plate is in thermal connection with the support frame, preferentially is joined to the support frame, more preferentially the cooling plate constitutes the support frame.

According to other optional features of the battery assembly according to the invention, taken either alone or in combination:
The battery cells of the battery module are connected in series or parallel.
The battery module comprises a metal locking plate, preferentially made of aluminum, screwed to the compression system and the cooling plate. Such a locking plate increases the heat exchange surface between the battery cells and the cooling plate.
The upper part of the battery module incorporates:
   means for positioning and securing electrical conduits or “busbars”;
   means for positioning and securing flexible printed circuit boards.

Another subject of the invention is a motor vehicle comprising a battery assembly according to the invention.

### BRIEF DESCRIPTION OF THE FIGURES

The invention will be better understood upon reading the following description, which is provided merely as example and with reference to the appended drawings, wherein:

FIG. 1 is an exploded view of a battery module of a battery assembly according to the invention.

FIG. 2 is a bottom view of the upper part of the battery module of a battery assembly shown in FIG. 1.

FIG. 3 is a cross-section of the upper part of the battery module of a battery assembly shown in FIG. 1.

FIG. 4 is a side view of part of a battery module compression system of a battery assembly shown in FIG. 1.

FIG. 5 is an exploded view of part of a compression system of the battery module of a battery assembly shown in FIG. 1.

FIG. 6 is a longitudinal section of the battery module of a battery assembly shown in FIG. 1.

FIG. 7 is a partial cross-section of the top of the support frame of the battery module of a battery assembly shown in FIG. 1.

FIG. 8 is a top view of the support frame of the battery module of a battery assembly shown in FIG. 1.

FIG. 9 is a bottom view of the upper part of the battery module of a battery assembly shown in FIG. 1 according to one embodiment of the invention.

### DETAILED DESCRIPTION

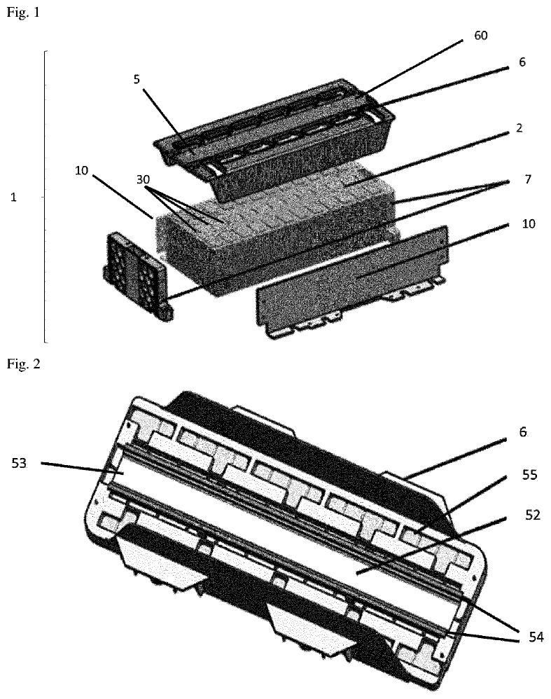

FIGS. 1 to 9 show a battery assembly according to one embodiment of the invention. In FIGS. 1 to 9, similar elements are designated by identical references.

FIG. 1 shows a battery module 1 of the battery assembly according to the invention. The battery module 1 comprises an alignment of a plurality of battery cells 2, each battery cell 2 being placed in an individual battery cell chamber 2 and separated from each other by a separation plate, each individual battery cell chamber comprising a vent 30 communicating with a gas discharge channel 5 arranged in an upper portion 6 of the battery module 1, said discharge channel 5 being common to the plurality of battery cells 2 and being located at the center 60 of the upper portion 6 of the battery module 1. The battery module 1 further comprises a compression system 7 with at least one gas outlet in fluid connection with the gas discharge channel 5. The battery module 1 comprises two metal locking plates 10, preferentially made of aluminum, screwed to the compression system 7 and the cooling plate. The locking plates 10 increase the heat exchange surface between the battery cells 2 and the cooling plate.

FIG. 2 discloses the upper part 6 of the battery module shown in FIG. 1. The upper part 6 of the battery module 1 comprises the upper wall 52 of the gas discharge channel, said wall comprising a plate configured to form a thermal shield and constituting the upper wall 52 of the gas discharge channel. It can be seen that folds in the upper wall formed by the plate configured to form a thermal shield form at least part of two side edges 54 of the channel for discharging gases generated by thermal runaway, these folds being in the form of a groove or angle. The upper part 6 further comprises means for positioning and securing electrical conduits or “busbars” 55, as well as means for positioning and securing flexible printed circuit boards (not shown).

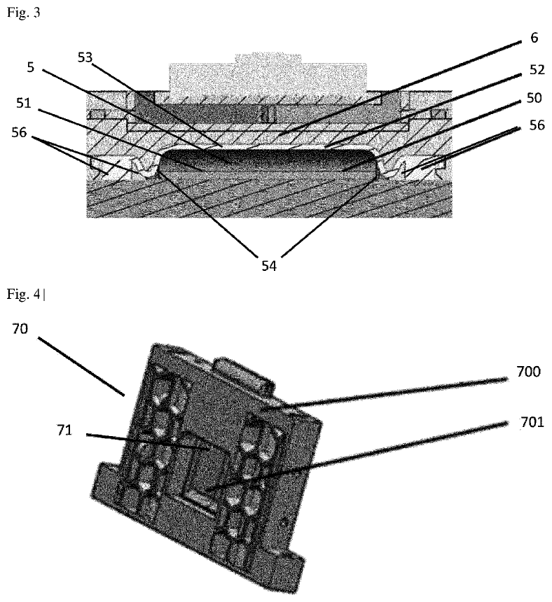

FIG. 3 shows a cross-section of the upper part 6 of the battery module 1 shown in FIG. 1. The upper part 6 of the battery module 1 comprises a channel 5 for the discharging of gases generated by thermal runaway, said channel being formed by a lower wall 50 consisting of a plate configured to form a thermal shield 51, an upper wall 52 consisting of a plate configured to form a thermal shield 53, and two side edges 54. The side edges 54 of the gas discharge channel 5 are formed, on the one hand, by a fold of the upper wall 52 constituted by the plate configured to form a thermal shield 53 and, on the other hand, by a polymer-based material 56. It can be seen that the side edges 54 are such that the polymer-based material 56 is inserted into a groove or angle present in the upper wall 52 constituted by the plate configured to form a thermal shield 53.

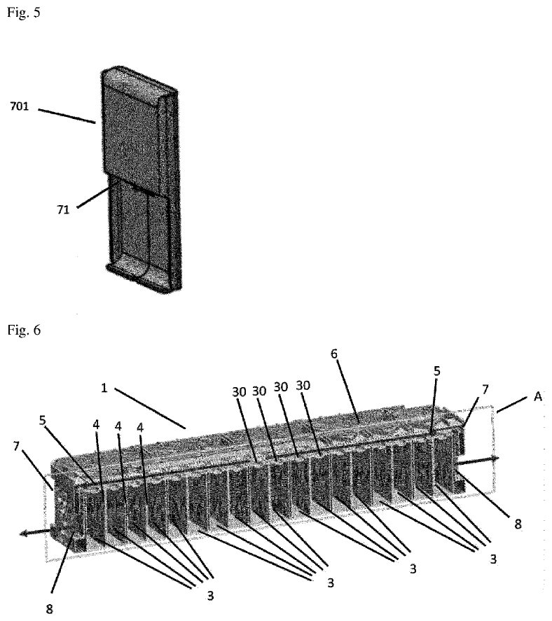

FIGS. 4 and 5 show one of the two plates 70 of the compression system. The plate 70 comprises a compression panel 700, preferentially made of polyphthalamide (PPA), and a thermal protection panel 701, preferentially made of steel, fitted with a gas outlet 71. FIG. 5 shows a view of the thermal protection panel 701 comprising a gas outlet 71.

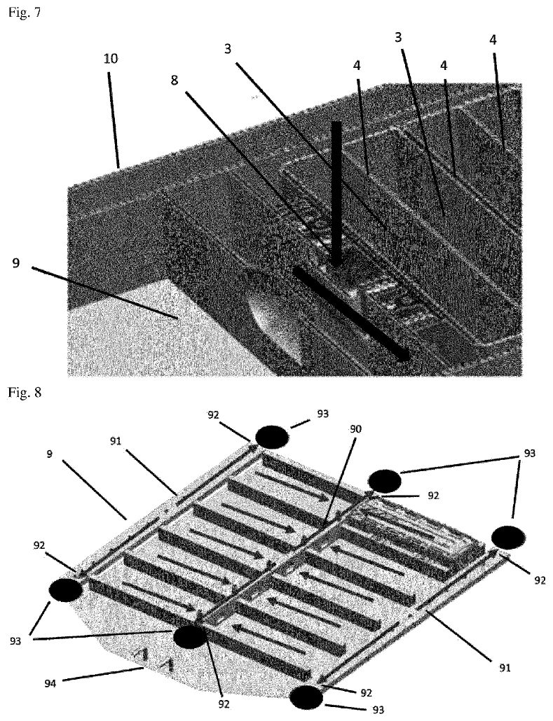

FIG. 6 shows a longitudinal section along a plane A of the battery module 1 of a battery assembly shown in FIG. 1. The battery module 1 comprises an alignment of a plurality of battery cells (not shown), each battery cell being placed in an individual battery cell 2 chamber 3 and separated from each other by a separation plate 4, each individual battery cell 2 chamber 3 comprising a vent 30 communicating with a gas discharge channel 5 arranged in an upper portion 6 of the battery module 1, said discharge channel 5 being common to the plurality of battery cells. The battery module 1 comprises a compression system 7 with at least one gas outlet 8 in fluid connection with the gas discharge channel 5. The arrows indicate the direction in which the gases generated by thermal runaway in the battery module 1 are discharged.

FIG. 7 shows a partial cross-section of the top of the support frame 9 of a battery module 1 of a battery assembly shown in FIG. 1 . The support frame 9 supports the individual battery cell chambers 3, separated from each other by separation plates 4. The metal locking plate 10 is in thermal connection with the support frame 9. The gas outlet 8 of the compression system is also shown. The arrow indicates the direction in which the gases generated by a thermal runaway flow.

FIG. 8 shows a top view of the support frame 9 of the battery module 1 of a battery assembly shown in FIG. 1. The support frame 9 comprises a gas exhaust line in the central part 90 of said support frame 9, a gas exhaust area on the outer edges 91 of the support frame 9, outlets 92 from the gas exhaust line in the central part 90 and from the gas exhaust area on the outer edges 91 of the support frame 9. Each outlet 92 is fitted with a safety valve 93. The support frame 9 includes a cold plate 94. The arrows indicate the direction in which the gases generated by thermal runaway in the battery module are discharged.

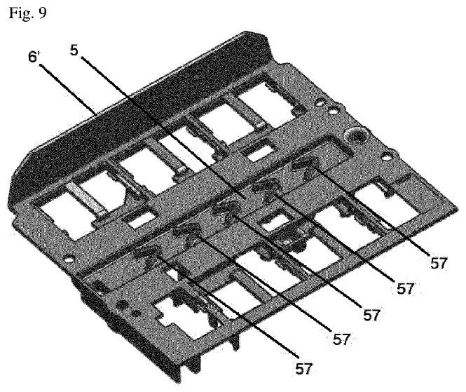

FIG. 9 shows a bottom view of an upper part 6′ of the battery module 1, according to one variant of the invention. The upper part 6′ of the battery module 1 differs from that shown above in that the discharge channel 5 arranged in the upper part 6′ of the battery module 1 has multiple baffles 57 configured to guide gases generated by thermal runaway, in order to discharge them more efficiently. Each baffle 57 takes the form of a straight rib in the general shape of a “V”, so that gas encountering one of the baffles arrives at the top of the “V” of this baffle and bypasses it on either side, so that the inside of the “V” is sheltered from the gas. In other words, the baffles form an arrow pattern whose direction is opposite to the direction of gas discharge within the discharge channel 5. The baffles 57 can be arranged in the discharge channel 5 so as to be located above some of the vents 30, or all of the vents 30, so that they open into the discharge channel 5 inside the “V” of one of the baffles 57. In this way, the vents 30 are protected from gases that may be generated by the thermal runaway of another battery cell 2, thus preventing these gases from damaging the vents 30.

### LIST OF REFERENCES

1: battery module
2: battery cell(s)
3: individual battery cell chamber
4: separation plate
5: gas discharge channel
6; 6′: upper part of battery module
7: compression system
8: compression system gas outlet
9: support frame
10: metal locking plate
30: vent of individual battery cell chamber
50: lower wall of gas discharge channel
51: plate configured to form a thermal shield constituting the lower wall of the gas discharge channel
52: upper wall of the gas discharge channel
53: plate configured to form a thermal shield constituting the upper wall of the gas discharge channel
54: two side edges of the gas discharge channel
55: means for positioning and securing an electrical conduit or busbar
56: polymer-based material
57: baffle
60: center of the upper part of the module
70: compression plates of the compression system
71: gas outlet from compression plate
90: gas exhaust line in central part of the support frame
91: gas exhaust area on outer edges of the support frame
92: outlet from gas exhaust line in the central part and from gas exhaust area on the outer edges of support frame
93: safety valve
94: cold plate
700: compression panel
701: thermal protection panel

1-11. (canceled)

12. A battery assembly comprising at least one battery module, said battery module comprising an alignment of a plurality of battery cells, each battery cell being placed in an individual battery cell chamber and separated from each other by a separation plate, each individual battery cell chamber comprises a vent communicating with a discharge channel for discharging the gases generated by thermal runaway arranged in an upper portion of the battery module, said discharge channel is common for the plurality of battery cells and comprises a lower wall made up of a plate configured to form a thermal shield, an upper wall made up of a plate configured to form a thermal shield and two side edges comprising a polymer-based material, and the battery module comprises a compression system provided with at least one gas outlet in fluid connection with the gas discharge channel.

13. The battery assembly according to claim 12, wherein the polymer-based material constituting the two side edges is covered with a metal film or a ceramic film, on at least its portions exposed to the gases generated by thermal runaway.

14. The battery assembly according to claim 12, wherein at least one of the two side edges of the channel for discharging gases generated by thermal runaway is constituted in part by a fold of the upper wall constituted by the plate configured to form a thermal shield.

15. The battery assembly according to claim 12, wherein the gas discharge channel is located in the center of the upper part of the battery module.

16. The battery assembly according to claim 12, wherein the compression system provided with at least one gas outlet in fluid connection with the gas discharge channel comprises at least two compression plates located on either side of the battery module in the direction of alignment of the plurality of battery cells, at least one of the two plates comprising a gas outlet in the form of a duct perpendicular to the direction of alignment of the plurality of battery cells, said duct being directed towards the bottom of the battery module.

17. The battery assembly according to claim 16, wherein said at least one of the two compression plates comprises a compression panel and a thermal protection panel comprising the gas outlet in the form of a duct perpendicular to the direction of alignment of the plurality of battery cells, said thermal protection panel being based on a material selected from a ceramic material and a metallic material.

18. The battery assembly according to claim 12, further comprising a support frame for at least one battery module, said support frame comprising a central gas exhaust line and a gas exhaust area on the outer edges of the support frame, the central gas exhaust line and the gas exhaust area on the outer edges of the support frame being in fluid connection with the gas outlet of the compression system.

19. The battery assembly according to claim 18, wherein the gas exhaust line in the central part and the gas exhaust area on the outer edges of the support frame are provided with an outlet comprising a safety valve.

20. The battery assembly according to claim 19, wherein the safety valve is a diaphragm valve.

21. The battery assembly according to claim 12, wherein the discharge channel arranged in the upper part of the battery module has multiple baffles configured to guide gases generated by thermal runaway.

22. A motor vehicle comprising a battery assembly according to claim 12.
